(19) United States
(12) Patent Application Publication
(10) Pub. No.: US 2020/0150136 A1
(43) Pub. Date: May 14, 2020

(54) CAPPING SYSTEM USED FOR SAMPLES BEFORE OCCURRENCE OF BIOLOGICAL THERMAL REACTION, AND METHOD OF USING THE SAME

(71) Applicant: TAIGEN BIOSCIENCE CORPORATION, Taipei City (TW)

(72) Inventor: CHI-SHENG TAI, Taipei City (TW)

(21) Appl. No.: 16/742,911

(22) Filed: Jan. 14, 2020

Related U.S. Application Data
(63) Continuation-in-part of application No. 15/597,081, filed on May 16, 2017.

(30) Foreign Application Priority Data
Jun. 15, 2016 (TW) 105118760

(51) Int. Cl. G01N 35/00; G01N 35/02

(52) U.S. Cl. CPC G01N 35/00693; G01N 35/0099; G01N 2035/0405; G01N 2035/00346; G01N 35/026

(57) ABSTRACT

The present invention provides a capping system used for samples before occurrence of biological thermal reaction, which comprises plurality of reaction tubes, a plurality of suckers, and a plurality of pushing rod. Each of the plurality of reaction tubes comprises an opening end. The plurality of suckers is used to suck a plurality of caps and move the plurality of caps to the opening end of the plurality of reaction tube. The plurality of pushing rob is used to push the plurality of caps into the opening end of the plurality of reaction tube.

### CROSS-REFERENCES TO RELATED APPLICATION

This application is a continuation-in-part of U.S. patent application Ser. No. 15/597,081, filed May 16, 2017, entitled “CAPPING SYSTEM FOR BIOLOGICAL THERMAL REACTION AND METHOD OF USING THE SAME”, which claims benefit of Taiwan patent application No. 105118760, filed on Jun. 15, 2016, both of which are incorporated by reference herein in their entirety.

### FIELD OF THE INVENTION

The present invention relates to a capping system used for samples before occurrence of biological thermal reaction, and a method of using the same, and in particular, is related to the biomedical industry, for applying on automated equipments.

### BACKGROUND OF THE INVENTION

In the biomedical laboratory, usually, reactants are usually put into a plastic reaction tube for generating biochemical reaction. It is common to seal the reaction tube for avoiding an influence from the external environment and keeping the consistency of the reaction condition. For bio-heat reactions, such as Polymerase Chain Reaction (PCR) needs to be processed over 90 Celsius degrees for several hours, whereby air-sealability is very important.

The conventional automated equipments applied for PCR use two kinds of methods for sealing the reaction tubes. 1. The reaction tubes are sealed by manual operation; and 2. the special-specification plastic tube and tools are used.

In the first method, during the operation of the automated equipments, the reaction tubes are token out to be sealed by manual operation. However, the manual operation might cause some reaction tubes sealed un-completely and time wasted.

In the second method, e.g. a Roch's COBAS Ampliprep is designed with the reaction tubes and caps having threads. It is found that although a sealability of the reaction tubes are ensured, a rotatable mechanism is needed for use, and furthermore, one cap is sealed for one operation; if multiple reaction tubes are simultaneously sealed, it is needed to use quite a few mechanisms, so that the manufacturing cost is raised. Meanwhile, the reaction tubes and caps with thread also means higher manufacturing cost (a common reaction tubes have no thread).

Furthermore, comparative with the first method, the second method is for a completely automated equipment. However, there are still several issues. 1. It is unable to know whether the cap is moved to the position of the reaction tube; 2. the cap might be slid down from the reaction tube when rotating; and 3. the rotatable mechanism is easily out of order.

Hence, it is essential to provide a capping system for biological thermal reaction and a method of using the same, so as to solve the above technical issues.

However, the conventional art provides solutions to the above-mentioned technical problems, but there is no effective way to solve the above-mentioned technical problems at the same time.

### SUMMARY OF THE INVENTION

In order to solve the aforementioned technical problems of the conventional art, an objective of the present invention is to provide provides a capping system having suckers and pushing rods which are driven to move respectively along different-dimensional directions by a plurality of different-dimensional driving devices. Accordingly, when the suckers are moved to suck a number of caps, it is determined whether the caps are sucked according to a pressure-detection device, and the caps can be correctly reached to above the reaction tube. The respective pushing rods are aligned to each of the caps, with a single-directional (e.g. X-axial direction) movement driven by a plurality of the different-dimensional driving devices, so as to further and accurately push each cap into each of the reaction tubes, with another single-directional (e.g. Z-axial direction) movement driven by another one of the different-dimensional driving devices.

In order to achieve the objective, the present invention provides a capping system used for samples before occurrence of biological thermal reaction, which comprises a lower seat, a plurality of different-dimensional driving devices, a control unit and an upper movable seat . . . .

The lower seat where a plurality of reaction tubes and a plurality of caps are positioned, wherein the reaction tubes used for accommodating the corresponding sample has an opening end, and the caps are used for covering the opening end of the corresponding reaction tubes.

The plurality of different-dimensional driving devices each comprises an actuator, and a guiding rail and/or an extendable arm, in connection with the actuator.

The control unit having a processor and a memory, used to control coordinate actuations among all of the different-dimensional driving devices.

The upper movable seat where a plurality of sucker and a plurality of pushing rods are disposed, linkage-driven to respectively move along different-dimensional directions by a number of the different-dimensional driving devices, with making the suckers to suck a plurality of the caps and then to move with sucking the plurality of caps together until the plurality of caps reaches above the opening end of the corresponding reaction tube, and then with making the pushing rods to movably push the plurality of caps into the corresponding reaction tubes through the opening end. The different-dimensional directions are perpendicular to each other.

In a preferred embodiment, the capping system further comprises a pressure-detection device for determining whether the plurality of suckers suck the plurality of the plurality of caps completely or not.

In a preferred embodiment, the capping system further comprises a calibrating device which is controlled by the control unit for aligning positions of the plurality of suckers with the plurality of caps and thereby performing a sucking process, for moving the plurality of caps in alignment with the positions of the plurality of reaction tubes and thereby performing a moving process, and for aligning positions of the plurality of rod with the plurality of caps and thereby performing a pushing process which pushes the plurality of caps into the opening end of the plurality of corresponding reaction tube.

In a preferred embodiment, a plurality of the different-dimensional driving device are used for driving the plurality of pushing rods to perform a pushing process which pushes the plurality of caps into the opening end of the plurality of corresponding reaction tubes.

In a preferred embodiment, the capping system further comprises an air-pressure device for providing an enough suction pressure for the plurality of suckers.

In a preferred embodiment, the capping system further comprises a pressure-relief device which is used for eliminating a suction pressure of the plurality of suckers, so as to make the plurality of caps departed from the plurality of suckers.

In a preferred embodiment, the different-dimensional directions include a first direction, and the different-dimensional driving devices includes a first driving device which comprises a first-directional guiding rail extended in the first direction, and a first actuator for linkage-driving the lower seat to move along the first-directional guiding rail.

In order to achieve the object, the present invention provides a capping method used for samples before occurrence of biological thermal reaction, which comprises steps of: a plurality of reaction tubes being positioned wherein each of the plurality of reaction tubes comprises an opening end and a sample; next, a plurality of suckers are moved to suck a plurality of caps, and then the suckers along with sucking the plurality of caps are moved together to reach above the opening ends of the plurality of reaction tubes by a driving device; and the plurality of caps are pushed by plurality of pushing rods into the opening end of the plurality of reaction tubes by the driving device.

In a preferred embodiment, the capping method further comprises a step of: whether the plurality of suckers suck the plurality of caps completely or not being determined by a pressure-detection device

In a preferred embodiment, the capping method further comprises a calibrating device for aligning positions of the plurality of suckers with the plurality of caps for performing a sucking process, for moving the plurality of caps in alignment with positions of the plurality of reaction tubes for performing a moving process, and for aligning positions of the plurality of rod with the plurality of caps for performing a pushing process which pushes the plurality of caps into the opening end of the plurality of corresponding reaction tube.

In a preferred embodiment, the capping method further comprises a step of using the driving device for actuating the plurality of pushing rods to perform a pushing process which pushes the plurality of caps into the opening end of the plurality of corresponding reaction tubes.

In a preferred embodiment, the capping method further comprises a step of using an air-pressure device for providing an enough suction pressure for the plurality of suckers.

In a preferred embodiment, the capping method further comprises a step of: using a pressure-relief device to eliminate a suction pressure of the plurality of suckers, to make the plurality of caps departed from the plurality of suckers.

Compared with the conventional art, the present invention provides suckers and pushing rods. When the suckers suck a cap, whether the caps are sucked is determined according to a pressure-detection device. The respective pushing rods are aligned with each of caps and perform a single direction movement, so as to accurately push each cap into each of reaction tubes.

### DESCRIPTION OF THE DIAGRAMS

The technical solution and the beneficial effects of the present invention are best understood from the following detailed description with reference to the accompanying figures and embodiments.

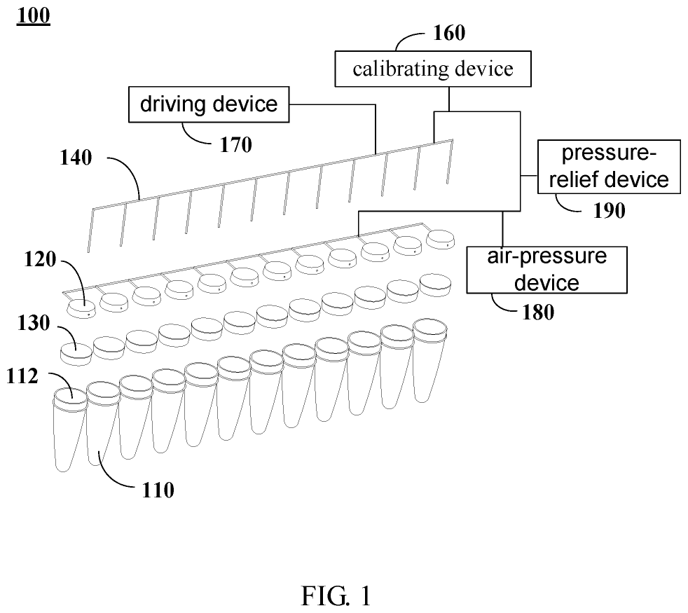

FIG. 1 is a disassembled schematic diagram of a capping system of a first preferred embodiment according to the present invention;

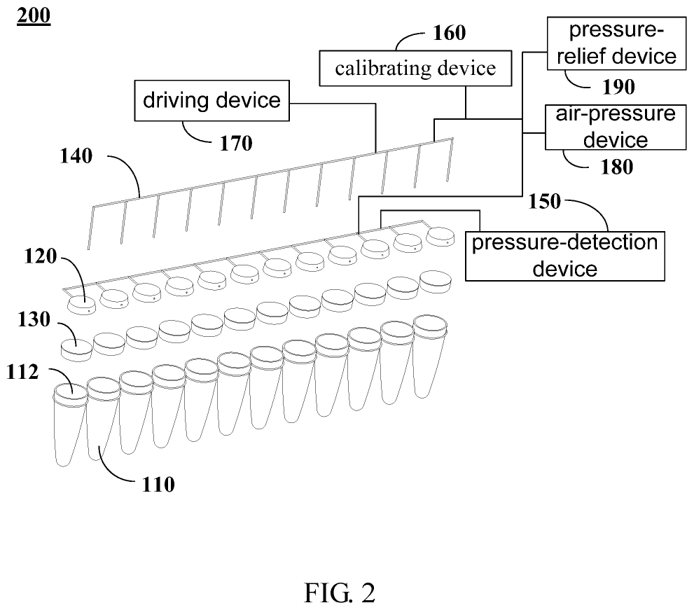

FIG. 2 is a disassembled schematic diagram of a capping system of a second preferred embodiment according to the present invention;

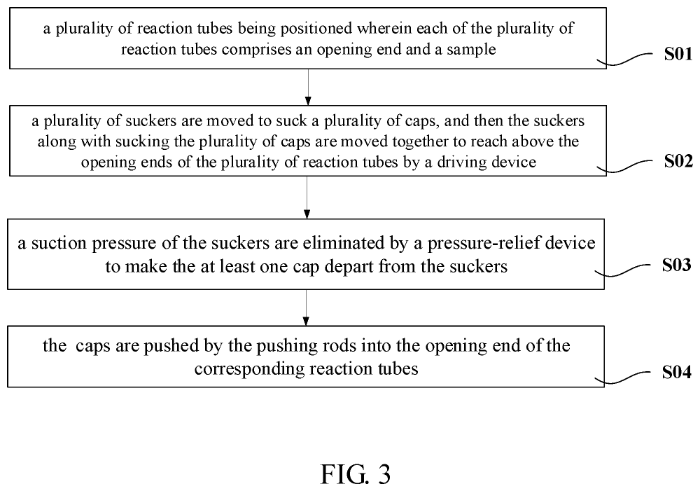

FIG. 3 is a flow diagram of a capping method of a first preferred embodiment according to the present invention;

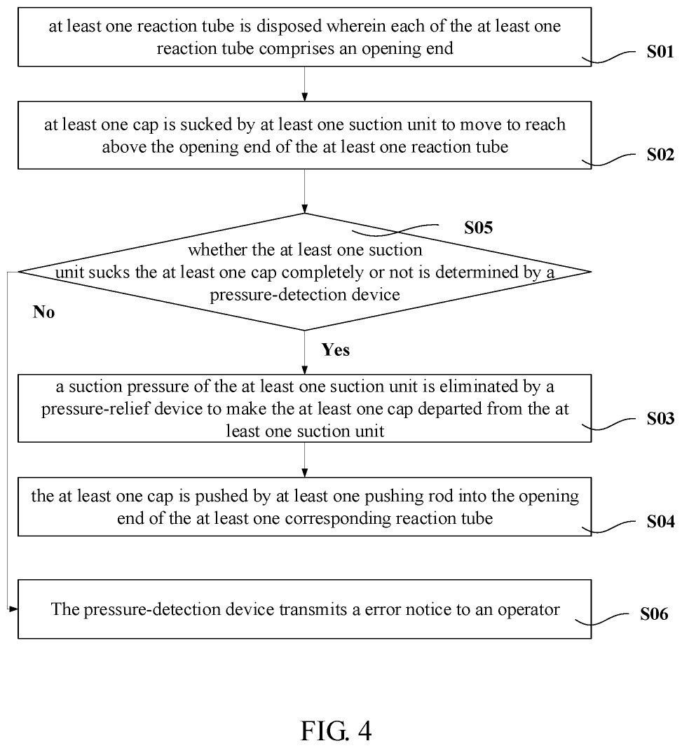

FIG. 4 is a flow diagram of a capping method of a second preferred embodiment according to the present invention;

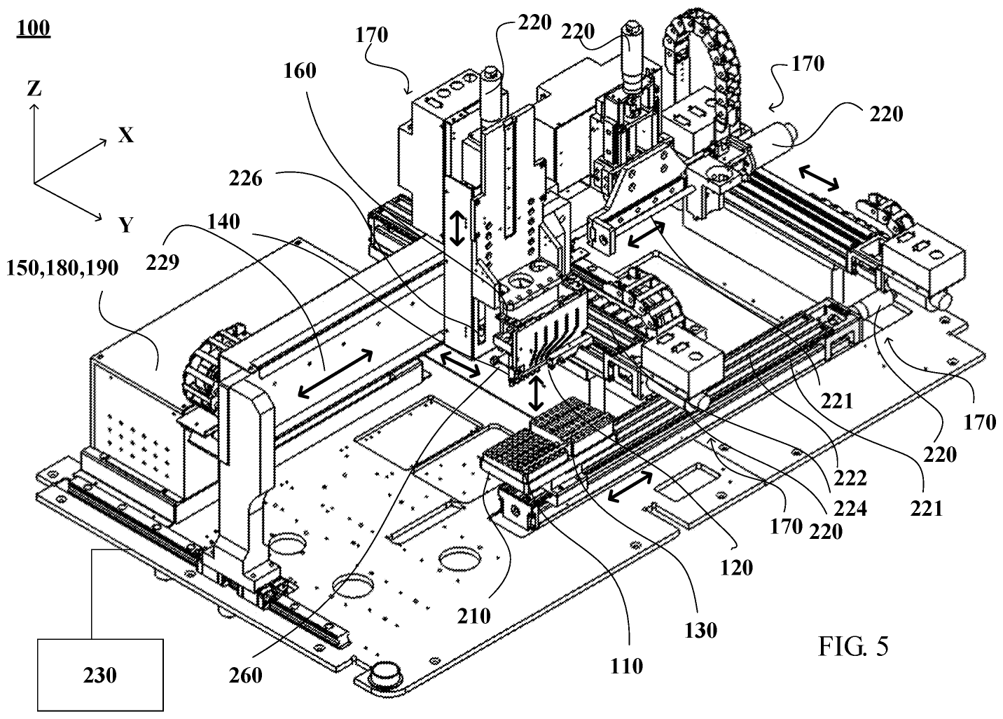

FIG. 5 depicts a stereoscopically schematic diagram of the capping system, according to the first preferred embodiment of the present invention, with introduction of a concrete structure thereof;

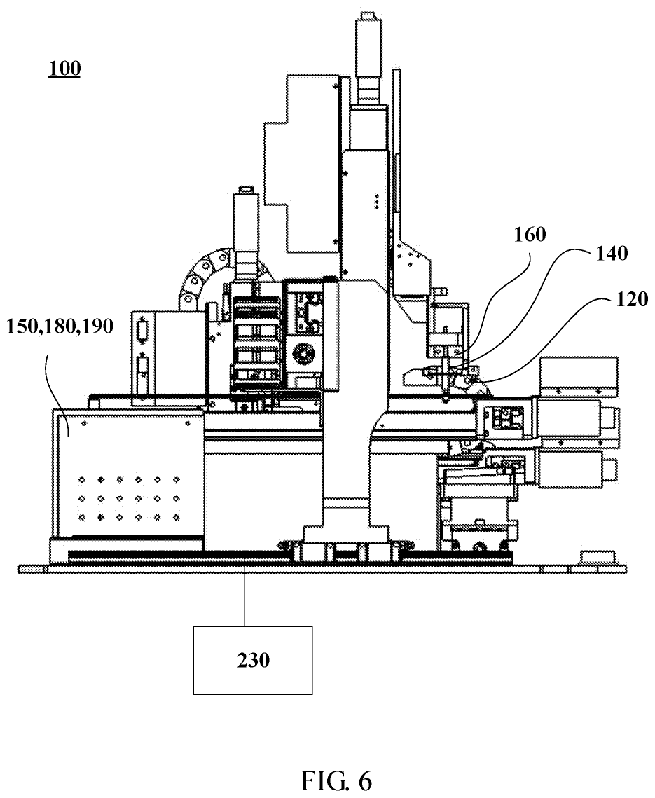

FIG. 6 depicts a laterally schematic diagram of the capping system shown in FIG. 5; and

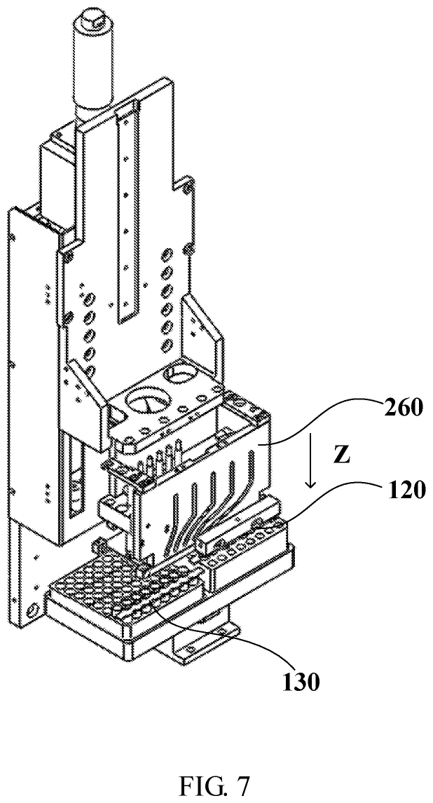

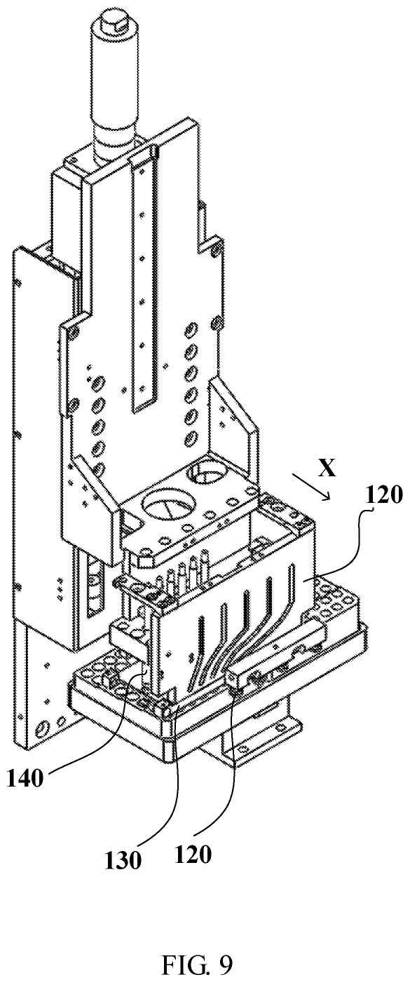

FIGS. 7-9 depict continuously-actuating diagrams of the capping system shown in FIG. 5.

### DETAILED DESCRIPTION OF THE PREFERRED EMBODIMENTS

The following description of the embodiments is given by way of illustration with reference to the specific embodiments in which the invention may be practiced. The terms such as “up”, “down”, “front”, “back”, “left”, “right”, “inside”, “outside”, “side”, etc., The direction of the diagram. Accordingly, the use of a directional term is used to describe and to understand the present invention and is not intended to limit the invention.

FIG. 1 is a disassembled schematic diagram of a capping system 100 of a first preferred embodiment according to the present invention. The capping system 100 used for samples before occurrence of biological thermal reaction, comprises a plurality of reaction tubes 110, a plurality of sucker 120, a plurality of pushing rod 140, a calibrating device 160, a driving device 170, an air-pressure device 180 and a pressure-relief device 190.

Each of the plurality of reaction tubes 110 comprises an opening end 112. In detail, the opening end 112 is used to store materials for bio-heat reaction. The bio-heat reaction is performed over 90 Celsius degrees. The plurality of suckers 120 is used for sucking plurality of caps 130 and moving the plurality of caps 130 to reach above the opening end 112 of the plurality of reaction tubes 110. The pressure-relief device 190 is used for eliminating a suction pressure of the plurality of suckers 120 to make the plurality of caps 130 depart from the plurality of suckers 120. Before the suction pressure of the plurality of suckers 120 is eliminated, the plurality of caps 130 is unable to be depart from the plurality of suckers 120. The plurality of caps 130 and/or the plurality of suckers 120 might be damaged to cause its air sealability decreased if an external force is applied to depart the plurality of suckers 120 from the plurality of caps 130. With the pressure-relief device 190, a pressure generated between the plurality of suckers 120 and the plurality of caps 130 can recover as same as the ambient pressure so that the plurality of caps 130 can be depart from the plurality of suckers 120, automatically. In detail, once the plurality of caps 130 is accurately pushed into the plurality of reaction tubes 110, the air-salability of the plurality of reaction tubes 110 can be ensured. The plurality of pushing rod 140 is used for pushing the plurality of caps 130 into the opening end 112 of the plurality of corresponding reaction tubes 110. Alternatively, with different mechanical design, it is possible to push the cap(s) into one (or multiple) reaction tubes 110.

The calibrating device 160 is used for aligning the plurality of suckers 120 with the plurality of caps 130 for performing a sucking process, for moving the plurality of caps 130 in alignment with the plurality of reaction tubes 110 for performing a moving process, and for aligning the plurality of rod 140 with the plurality of caps 130 for performing a pushing process, to make the plurality of caps 130 into the opening end 112 of the plurality of corresponding reaction tubes 110.

In detail, the calibrating device can align the position with laser. The driving device 170 is used for actuating the plurality of rod 140 to perform a pushing process, so as to make the plurality of caps 130 into the opening end 112 of the plurality of corresponding reaction tubes 110. In detail, the driving device 170 can be one or a combination of air-actuation device and oil-actuation device. The air-pressure device 180 is used for providing an enough suction pressure for the plurality of suckers 120. In detail, the air-pressure device 180 can be vacuum pump or a device for extracting air.

Preferably, the driving device 170 can be incorporated into the air-pressure device 180, the pushing rods 140 performs the pushing process with the force provided by the air-pressure device, so as to push the plurality of caps 130 into the opening end 112 of the plurality of corresponding reaction tubes 110.

In actual operation, first, the reactants are disposed inside the plurality of reaction tubes 110; then, the calibrating device 160 aligns the position of the plurality of reaction tubes 110; next, the plurality of suckers 120 sucks the plurality of caps 130 and moves the plurality of caps 130 to reach above the opening end 112 of the plurality of reaction tubes 110 (which just relies thereon but is not sealed yet by the cap); next, the pressure-relief device 190 eliminates the suction pressure of the plurality of suckers 120 to make the plurality of caps 130 depart from the plurality of suckers 120; next, the plurality of pushing rod 140 simultaneously pushes the plurality of caps 130 into the opening end 112 of the plurality of corresponding reaction tubes 110, to form an air-tight sealing. Next, the reaction tubes 110 can be used for bio-chemistry experiments. In the above operation process, with a linear operation (down-press movement) of the plurality of pushing rod 140, the automatic bio-heat reaction equipment can accomplish a complete automation and raise its sealing speed. Generally speaking, a bio-heat reaction over 90 Celsius degrees requires a very high level of air-sealability, the capping system of the present invention can be structured in air-tight sealing to ensure the safety of the high temperature bio-heat reaction (over 90 Celsius degrees).

FIG. 2 is a disassembled schematic diagram of a capping system 200 of a second preferred embodiment according to the present invention. A difference of the second preferred embodiment from the first preferred embodiment is adding of one pressure-detection device 150. In the first preferred embodiment, the plurality of caps 130 is sucked by the air-pressure device 180, so that it is possible that some of the caps may be not sucked. The pressure-detection device 180 is used to determine whether the plurality of suckers 120 sucks the plurality of caps 130 completely or not. In detail, when the plurality of suckers 120 completely sucks the plurality of caps 130, the pressure-detection device 180 will detect a specific vacuum degree; on the contrary, when the plurality of suckers 120 does not suck the plurality of caps 130, the pressure-detection device 180 will transmit a error notice to an operator (via a control unit 230 as shown in FIG. 5) depending on the atmospheric pressures of the related suckers 120 actually detected by the pressure-detection device 180, such that the operator can notice the error and correct it.

FIG. 3 is a flow diagram of a capping method of a first preferred embodiment according to the present invention (wherein the numerals of the elements are referred to FIG. 1). First, by performing a step S01, plurality of reaction tubes 110 is disposed wherein each of the plurality of reaction tubes 110 comprises an opening end 112; next, by performing a step S02 plurality of caps 130 is sucked by plurality of suckers 120 to move to reach above the opening end 112 of the plurality of reaction tubes 110; next, by performing a step S03, a suction pressure of the plurality of suckers 120 is eliminated by a pressure-relief device 190 to make the plurality of caps 130 depart from the plurality of suckers 120; and finally, by performing a step S04, the plurality of caps 130 is pushed by plurality of pushing rod 140 into the opening end 112 of the plurality of corresponding reaction tubes 110.

FIG. 4 is a flow diagram of a capping method of a second preferred embodiment according to the present invention (the numerals of the elements are referred to FIG. 1). A difference of the second preferred embodiment from the first preferred embodiment further comprises a step S05 between the step S02 and the step S03. In the step 505, whether the plurality of suckers 120 sucks the plurality of caps 130 completely or not is determined by a pressure-detection device 150. In detail, when the pressure-detection device 180 detects a specific vacuum degree, then the step S03 is performed; on the contrary, when the plurality of suckers 120 does not suck the plurality of caps 130, a step S06 will be performed, where the pressure-detection device 180 will transmit a error notice to an operator (via a control unit 230 as shown in FIG. 5) depending on the atmospheric pressure of the related suckers 120 actually detected by the pressure-detection device 180, such that the operator can notice the error and correct it, rather than performing the step S03 to cause the equipment damaged.

As described above, although the present invention has been described with the preferred embodiments thereof, those skilled in the art will appreciate that various modifications, additions, and substitutions are possible without departing from the scope and the spirit of the invention. Accordingly, the scope of the present invention is intended to be defined only by reference to the claims.

In the present invention, the time to utilize the capping system 100 and the capping method is earlier than the time to perform a biological thermal reaction of the samples. Next, the sample may have some reaction during mixing; however the reaction rate is very low. As mentioned above, since the capping system 100 and the capping method according to the present invention are used for the samples before occurrence of biological thermal reactions, the heating device and the thermal control device as known equipments will not need to be discussed in the present disclosure.

Please further refer to FIGS. 5-6, wherein FIG. 5 depicts a stereoscopically schematic diagram of the capping system 100, according to the first preferred embodiment of the present invention, with introduction of a concrete structure thereof, and FIG. 6 depicts a laterally schematic diagram of the capping system 100 shown in FIG. 5.

In FIGS. 5-6, the capping system 100 used for samples before occurrence of biological thermal reaction, comprises a plurality of reaction tubes 110, a plurality of caps 130, four suckers 120, six pushing rods 140, a pressure-detection device 150, a calibrating device 160, a plurality of different-dimensional driving devices 170, an air-pressure device 180, a pressure-relief device 190 and a control unit 230.

Referring to FIGS. 5-6, the reaction tubes 110 (which is not covered by the caps 130 yet) and the caps 130 are respectively arranged in two side-by-side arrays and positioned on a lower movable seat 210. The suckers 120 and the pushing rods 140 are disposed on an upper movable seat 226. The lower seat 210 (where the reaction tubes 110 and the caps 130 are positioned) and the upper movable seat 226 (where the suckers 120 and the pushing rods 140 are disposed) can be respectively linkage-driven to move to reach different predetermined positions along three-dimensional directions by a number of the different-dimensional driving devices 170 all which are respectively controlled in coordinate actuations there among by the control unit 230. In the embodiment, the different-dimensional driving devices 170 are respectively deployed for movements of various elements of the capping system 100 in three-dimensional axes (e.g. X, Y, Z axes), comprises a first driving device 170 used for driving the caps 130 and the reaction tubes 120 to move, and a second driving device 170, a third driving device 170 and a fourth driving device 170 used for driving the corresponding suckers 120 and the corresponding pushing rods 140 to move in forth-and-back manner. Each of the different-dimensional driving devices 170 comprise an actuator (such as an electric motor), and a single-directional extendable arm and/or a single-directional guiding rail, in connection with the actuator. For example, the lower seat 210 where the reaction tubes 110 and the caps 130 are positioned can be linkage-driven to move along a first direction (e.g. X-axial direction) by the first driving device 170 which comprises a first-directional guiding rail 222 extended in the first direction, and a first actuator 220 having an extendable arm for linkage-driving the lower seat 210 to move along the first-directional guiding rail 222, and the upper movable seat 226 where the suckers 120 and the pushing rods 140 are disposed can be driven to move individually along either of the first direction, a second direction and a third direction (e.g. X, Y, Z axial directions) by the corresponding one of the second driving device 170, the third driving device 170 and the fourth driving device 170. In a case, by the fourth driving device 170 which comprises a third-directional guiding rail 226 extended in the third direction (e.g. Z-axial direction) and an fourth actuator 220 having an extendable arm for linkage-driving the upper movable seat 260 to move along the third-directional guiding rail 226, the pushing rods 140 is driven to descend along the third direction to push the caps 130 in a position in alignment with above the reaction tubes 110, and then ascend to leave away from the reaction tubes 110. In an alternative embodiment, the ascending and descending movements of the pushing rods 140 for pushing the caps 130 can be driven by the air-pressure device 180 with another air tubes (not shown).

Further referring to FIG. 5, the suckers 120 are gas-communicated with the air-pressure device 180 through an air tubes (not shown). In detail, the air-pressure device 180 can be realized as an air pump which is used to create a vacuum suction for the suckers 120. When the suckers 120 as suckers need to suck the caps 130 up, the air-pressure device 180 will make the suckers generating a suction pressure which is lower than 1 atmosphere pressure or 1 atm. Next, as long as the suckers 120 suck-transfer the corresponding caps 130 to reach above the opening ends 112 (see FIG. 1) of the corresponding reaction tubes 110, the pressure-relief device 190 will be used to relief the suction pressure inside the suckers 120 to be equal to 1 atm. In this embodiment, the pressure-relief device 190 can be a pressure-relief valve disposed inside/outside the air-pressure device 180. For example, when the pressure-relief device 190 is activated, the suction pressure will gradually or immediately become 1 atm to make the suckers 120 losing the sucking ability to suck the caps 130; otherwise, when the pressure-relief device 190 is not activated, the suction pressure will keep on a specific pressure which is lower than 1 atm, so the suckers 120 have sucking ability to suck the caps 130.

Further referring to FIG. 5, the pressure-detection device 150 such as a pressure-detection sensor is used to detect the suction pressure of the suckers 120, thereby determining whether the caps 130 are successfully sucked up or not. If the pressure-relief device 190 is not activated and/or there is air leakage occurring among the air-pressure device 180, the pressure-relief device 190 and the relevant air tube, the caps will not be successfully sucked up with the suckers 120. In other words, if the suction pressure is detected unstable at the specific pressure which is lower than 1 atm, the pressure-detection device 150 will determine this situation as not complete suction. On the other hand, if the suction pressure is detected stable at the specific pressure which is lower than 1 atm, the pressure-detection device 150 will determine this situation as complete suction.

Further referring to FIGS. 5-6, the calibrating device 160, such as a calibrating laser meter, CCD and so fourth, is launched under control of the control unit 230 and is mounted close to the pushing rods 140 or the suckers 120, so the calibrating device 160 will be moved along with the suckers 120 and the pushing rods 140 during the whole process of the capping method. In the sucking process, the calibrating device 160 is used to align the positions of the suckers 120 with respect to the caps 130. In other words, the suckers 120 will be moved depending upon the calibrating device 160 measuring whether the suckers 120 do not touch or are not close enough to suck the caps 130. In the moving process, the calibrating device 160 is used to ensure that the caps 130 all are positioned on the top of the reaction tubes 110. In the pushing process, the calibrating device 160 is used to ensure the positions of the pushing rods which are centered above the opening ends 112 (see FIG. 1) along a vertical line, thereby ensuring that each of the pushing rods 140 are vertically downward to push the caps 130. The calibrating device 160 can be other optically calibrating meter which is launched under control of the control unit 230. Or the calibration process could be done manually. In other embodiment, the calibrating device 160 is used for aligning the positions of all the units mentioned above.

Further referring to FIGS. 5-6, the suckers 120, the pushing rods 140, the pressure-detection device 150, the calibrating device 160, the driving device 170, the air-pressure device 180, the pressure-relief device 190 and the different-dimensional robotic arms 220 all are controlled in their coordinate actuations by the control unit 230 in accordance with pre-specified actuating sequences and determining logics. For example, the control unit 230 can be a SOC, a PLC, a computer or other computerized device that comprises plurality of processor, MCU or CPU, and memory (e.g. RAM/ROM) and Input/output transmission interfaces, which is capable to command the above devices for performing programs related to the sucking process, the moving process and the pushing process as mentioned above.

Please further refer to the illustrations of FIGS. 7-9, which depict continuously-actuating diagrams of the capping system 100 shown in FIG. 5.

Firstly, as shown in FIGS. 5 and 7, the suckers 120 of the upper movable seat 260 is driven to move forwardly toward the caps 130 in the second row on the lower seat 210 along the second direction (e.g. Y-axial direction) by the third driving device 170 which comprises a second-directional guiding rail 224 extended in the second direction, and an third actuator 220 having an extendable arm for linkage-driving the suckers 120 of the upper movable seat 260 to move along the second-directional guiding rail 224, and/or the suckers 120 of the upper movable seat 260 is driven to move downwardly to reach the caps 130 in the second row on the lower seat 210 along the third direction (e.g. Z-axial direction) by the fourth driving device 170, and then the suckers 120 sucks the caps 130 via the air tubes (not shown) while the air-pressure device 180 is activated to generate the suction pressure but the pressure-relief device 190 is not activated. In a case, only two suckers 120 are used for sucking the corresponding caps 130 all which are arranged in side-by-side connection with each other to be a line after injection molding. If the total weight of the corresponding caps 130 is too heavy, the amount of the to-be-used suckers 120 or the suction pressure may be increased.

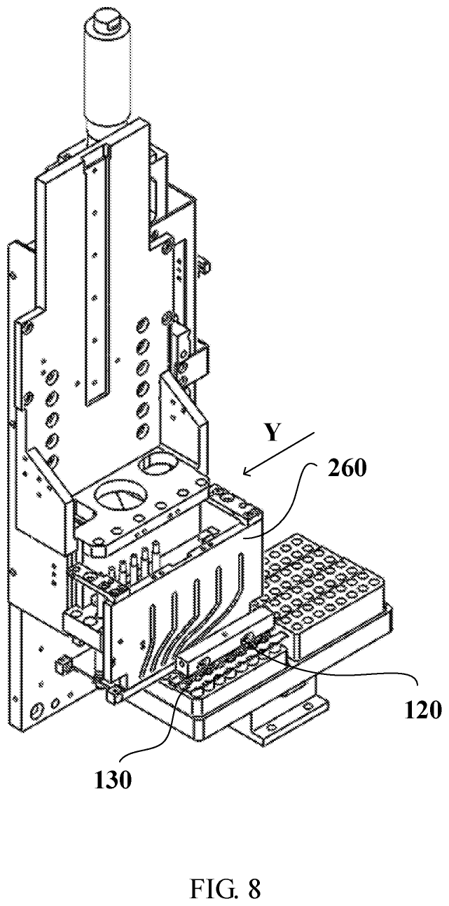

Next referring to FIGS. 5 and 8, the upper movable seat 260 where the suckers 120 and the pushing rods 140 are disposed are driven to move along the first direction (e.g. X-axial direction) toward the left side of the lower seat 210 by the second driving device 170 which includes a second actuator 220 having an extendable arm 221 for linkage-driving the suckers 120 of the upper movable seat 260, along with sucking the corresponding caps 130 together, to move along the second-directional guiding rail 229 extended in the first direction, until the suckers 120 reach above and align with the opening ends 112 (see FIG. 1) of the corresponding reaction tubes 110 in the same second or different row, and then the pressure-relief device 190 is activated to eliminate the suction pressure such that the corresponding caps 130 can be released from suction of the suckers 120 to be put on the corresponding reaction tubes 110 (as just leaning on the corresponding reaction tubes 110).

Next referring to FIGS. 1, 5 and 9, after the caps 130 are released from the suckers 120 to be put on the corresponding reaction tubes 110, an upper movable seat 260 where the suckers 120 and the pushing rods 140 are positioned are driven to move forwardly along the second direction (e.g. Y-axial direction) by the third driving device 170 which includes the second-directional guiding rail 224 and the third actuator 220 for linkage-driving the pushing rods 140 of the upper movable seat 260 to move along the second-directional guiding rail 224 extended in the second direction, until the pushing rods 140 respectively align with the opening ends 112 of the second row of the reaction tubes 110. Then, the pushing rods 140 are driven to vertically descend along the third direction (e.g. Z-axial direction) by the fourth driving device 170 which includes the third-directional guiding rail 226 and the fourth actuator 220 for linkage-driving the pushing rods 140 of the upper movable seat 260 to move along the third-directional guiding rail 226 extended in the third direction, so as to push the caps 130 into the corresponding reaction tubes 110 through the opening ends 112 to be an interference fit manner between the caps 130 and the opening ends 112 of the corresponding reaction tubes 110. In this embodiment, the number of the pushing rods 140 should be the same with the number of the caps 130 for ensuring that each of the caps 130 could be pushed into the reaction tubes 110.

What is claimed is:

1. A capping system used for samples before occurrence of biological thermal reaction, comprising:
a lower seat where a plurality of reaction tubes and a plurality of caps are positioned, wherein the reaction tubes used for accommodating the corresponding sample has an opening end, and the caps are used for covering the opening end of the corresponding reaction tubes;
a plurality of different-dimensional driving devices each comprising an actuator, and a guiding rail and/or an extendable arm, in connection with the actuator;
a control unit having a processor and a memory, used to control coordinate actuations among all of the different-dimensional driving devices; and
an upper movable seat where a plurality of sucker and a plurality of pushing rods are disposed, linkage-driven to respectively move along different-dimensional directions by a number of the different-dimensional driving devices, with making the suckers to suck at least one of the caps and then to move with sucking the at least one cap together until the at least one caps reaches above the opening end of the corresponding reaction tube, and then with making the pushing rods to movably push the plurality of caps into the corresponding reaction tube through the opening end, wherein the different-dimensional directions are perpendicular to each other.

2. The capping system according to claim 1, further comprising a pressure-detection device for determining whether the plurality of sucker suck the plurality of the plurality of caps completely or not.

3. The capping system according to claim 1, further comprising a calibrating device is controlled by the control unit, for aligning positions of the plurality of suckers with the plurality of caps and thereby performing a sucking process, for moving the plurality of caps in alignment with positions of the plurality of reaction tubes and thereby performing a moving process, and for aligning positions of the plurality of rod with the plurality of caps and thereby performing a pushing process which pushes the plurality of caps into the opening ends of the plurality of corresponding reaction tubes.

4. The capping system according to claim 1, wherein at least one of the different-dimensional driving device are used for driving the plurality of pushing rods to perform a pushing process which pushes the plurality of caps into the opening end of the plurality of corresponding reaction tubes.

5. The capping system according to claim 1, further comprising an air-pressure device for providing an enough suction pressure for the plurality of suckers.

6. The capping system according to claim 1, further comprising a pressure-relief device used for eliminating a suction pressure of the plurality of suckers, to make the plurality of caps departing from the at least one of the plurality of suckers.

7. The capping system according to claim 1, wherein the different-dimensional directions include a first direction and the different-dimensional driving devices includes a first driving device which comprises a first-directional guiding rail extended in the first direction, and a first actuator for linkage-driving the lower seat to move along the first-directional guiding rail.

8. A capping method used for samples before occurrence of biological thermal reaction, comprising steps of:
positioning a plurality of reaction tubes wherein each of the plurality of reaction tubes comprises an opening end and a sample;
moving a plurality of suckers to suck at least one of a plurality of caps and then moving the suckers along with sucking the plurality of caps together to reach above the opening ends of the plurality of reaction tubes by a driving device; and
pushing the plurality of caps by a plurality of pushing rods into the opening end of the plurality of corresponding reaction tubes by the driving device.

9. The capping method according to claim 8, further comprising a step of: using a pressure-detection device to determine whether the plurality of suckers suck the at least one of the plurality of caps completely or not.

10. The capping method according to claim 8, further comprising a step of using a calibrating device for aligning positions of the plurality of suckers with the plurality of caps for performing a sucking process, for moving the plurality of caps in alignment with positions of the plurality of reaction tubes for performing a moving process, and for aligning positions of the plurality of pushing rods with the plurality of caps for performing a pushing process which pushes the plurality of caps into the opening ends of the plurality of corresponding reaction tubes.

11. The capping method according to claim 8, further comprising a step of using the driving device for actuating the plurality of pushing rods to perform a pushing process which pushes the plurality of caps into the opening ends of the plurality of corresponding reaction tubes.

12. The capping method according to claim 8, further comprising a step of using an air-pressure device for providing an enough suction pressure for the plurality of suckers.

13. The capping method according to claim 8, further comprising a step of: eliminating a suction pressure of the plurality of suckers by a pressure-relief device, to make the at least one of the plurality of caps depart from the plurality of suckers.
